(19) United States
(12) Patent Application Publication
(10) Pub. No.: US 2018/0039905 A1
(43) Pub. Date: Feb. 8, 2018

(54) LARGE SCALE DISTRIBUTED TRAINING OF DATA ANALYTICS MODELS

(71) Applicant: International Business Machines Corporation, Armonk, NY (US)

(72) Inventors: Andreea S. Anghel, Adliswil (CH); Bogdan Prisacari, Adliswil (CH)

(21) Appl. No.: 15/227,101

(22) Filed: Aug. 3, 2016

(51) Int. Cl. G06N 99/00

(52) U.S. Cl. CPC G06N 99/005

(57) ABSTRACT

Embodiments train data analytics models by fitting that is distributed computationally and from a data storage point of view to produce an equivalent model to that achieved by sequential fitting. For example, a method may include performing a first pass on an untrained model at a first node, repeatedly transmitting the model to a next node and training the data analytics model at the next node until the data analytics model has been trained by at least a portion of the plurality of processing nodes. There may be a plurality of models that need to be fitted on the dataset and that may be independent or may result from varying and choosing different combinations of model structure, model meta-parameters that are not learned through training, and training algorithm parameters. Embodiments may provide the capability for training multiple models simultaneously by performing the single-model fitting process on different successions of nodes.

### BACKGROUND

The present invention relates to techniques for training of data analytics models by fitting that is distributed computationally and from a data storage point of view and that is able to produce an equivalent model to that achieved by sequential fitting.

Extracting knowledge from data is now more than ever essential for business development. Recently, it has become evident that data analytics models/frameworks will need to be able to reach unprecedented scale to be able to effectively handle the Big Data explosion. The challenges are two-fold: i) such models need to scale computationally such that knowledge can be extracted in a practical amount of time, and ii) such models need to scale data-wise, as they need to be able to process quantities of data that would not fit on a single machine or even in the main memory of an entire distributed system. Exploiting parallelism is thus a necessity.

The training of a machine learning model is typically done by finding a set of model parameters that globally minimizes some error function. Parallel approaches typically work on subsets of the data concurrently to maximize performance. The drawback is that in working separately on subset, each subset may not include enough information so that the global optimum can be computed. While a sequential approach is typically much slower, it also has the potential to achieve better accuracy. Nonetheless, the prevailing approach is the parallel approach, that is computing partial models (one for each subset into which the global dataset is partitioned) and then merging them in the end (typically non-optimally). This may work reasonably well for certain problems (for example, when the model parameter space is convex) and not so well for others (for example, K-Means clustering, where the model parameter space has multiple local optima).

In addition, often the competitive advantage of a data analytics solution is not gained by completely reinventing algorithms/models as much as by intelligent construction and selection of the feature space and the exploration of the model meta-parameter space. For a given dataset and model, a huge number of combinations of dataset views (feature construction and selection) and model versions (model meta-parameter space) must to be evaluated. This means that the problem is no longer the original single computationally- and IO-hard problem, but rather thousands or more instances of equally hard such problems.

Accordingly, a need arises for techniques by which such large-scale data analytics models may be developed to provide improved performance and reduced cost.

### SUMMARY

Embodiments of the present invention may provide the capability for training of data analytics models by fitting that is distributed computationally and from a data storage point of view and that is able to produce an equivalent model to that achieved by sequential fitting. Given a multi-node distributed computing system data parallelism and in-memory computation may be achieved by distributing the dataset onto the available nodes. Likewise, sequential-equivalence may be achieved by transmitting from node to node not the data, but the intermediate models, and performing computation only on local data (bringing thus computation to the data, not the other way around). Further, computational parallelism may be achieved by training multiple models and considering multiple dataset views.

In an embodiment of the present invention, a computer-implemented method for training of data analytics models may comprise dividing a dataset among a plurality of processing nodes, each processing node comprising at least one processor, memory, and communications circuitry, the memory of each processing node storing a different portion of the dataset, performing a first training pass on an untrained data analytics model by receiving at a first node the untrained data analytics model, training the untrained data analytics model by integrating the portion of the dataset stored on the first node into the data analytics model, repeating transmitting the data analytics model to a next node and training the data analytics model at the next node by integrating the portion of the dataset stored on the next node into the data analytics model until the data analytics model has been trained by at least a portion of the plurality of processing nodes, and outputting the trained data analytics model.

In an embodiment of the present invention, the method may further comprise performing at least one additional training pass on the data analytics model. The output trained data analytics model may have similar accuracy to a data analytics model trained by training the data analytics model with the dataset sequentially. The method may further comprise training a plurality of data analytics models, the plurality of data analytics models resulting from varying and choosing different combinations of model structure, model meta-parameters that are not learned through training, and training algorithm parameters. The method may further comprise training the plurality of data analytics models simultaneously using the plurality of processing nodes, each data analytics model trained on the plurality of processing nodes using a different succession of processing nodes than the successions of processing nodes with which other data analytics models are trained. The method may further comprise training a plurality of data analytics models, wherein at least some of the plurality of data analytics models are independent of each other and training the plurality of data analytics models simultaneously using the plurality of processing nodes, each data analytics model trained on the plurality of processing nodes using a different succession of processing nodes than the successions of processing nodes with which other data analytics models are trained.

In an embodiment of the present invention, a computer program product for training of data analytics models may comprise a non-transitory computer readable storage having program instructions embodied therewith, the program instructions executable by a computer, to cause the computer to perform a method comprising dividing a dataset among a plurality of processing nodes, each processing node comprising at least one processor, memory, and communications circuitry, the memory of each processing node storing a different portion of the dataset, performing a first training pass on an untrained data analytics model by receiving at a first node the untrained data analytics model, training the untrained data analytics model by integrating the portion of the dataset stored on the first node into the data analytics model, repeating transmitting the data analytics model to a next node and training the data analytics model at the next node by integrating the portion of the dataset stored on the next node into the data analytics model until the data analytics model has been trained by at least a portion of the plurality of processing nodes, and outputting the trained data analytics model.

In an embodiment of the present invention, a system for training of data analytics models, the system may comprise a processor, memory accessible by the processor, and computer program instructions stored in the memory and executable by the processor to perform dividing a dataset among a plurality of processing nodes, each processing node comprising at least one processor, memory, and communications circuitry, the memory of each processing node storing a different portion of the dataset, performing a first training pass on an untrained data analytics model by receiving at a first node the untrained data analytics model, training the untrained data analytics model by integrating the portion of the dataset stored on the first node into the data analytics model, repeating transmitting the data analytics model to a next node and training the data analytics model at the next node by integrating the portion of the dataset stored on the next node into the data analytics model until the data analytics model has been trained by at least a portion of the plurality of processing nodes, and outputting the trained data analytics model.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary block diagram of a distributed computing system.

FIG. 2 is an exemplary flow diagram of a process for distributed data analytics model fitting.

FIG. 3 is an exemplary block diagram of a computer system in which processes involved in the embodiments described herein may be implemented.

### DETAILED DESCRIPTION

Embodiments of the present invention may provide the capability for training of data analytics models by fitting that is distributed computationally and from a data storage point of view and that is able to produce an equivalent model to that achieved by sequential fitting. Given a multi-node distributed computing system data parallelism and in-memory computation may be achieved by distributing the dataset onto the available nodes. Likewise, sequential-equivalence may be achieved by transmitting from node to node not the data, but the intermediate models, and performing computation only on local data (bringing thus computation to the data, not the other way around). Further, computational parallelism may be achieved by training multiple models and considering multiple dataset views.

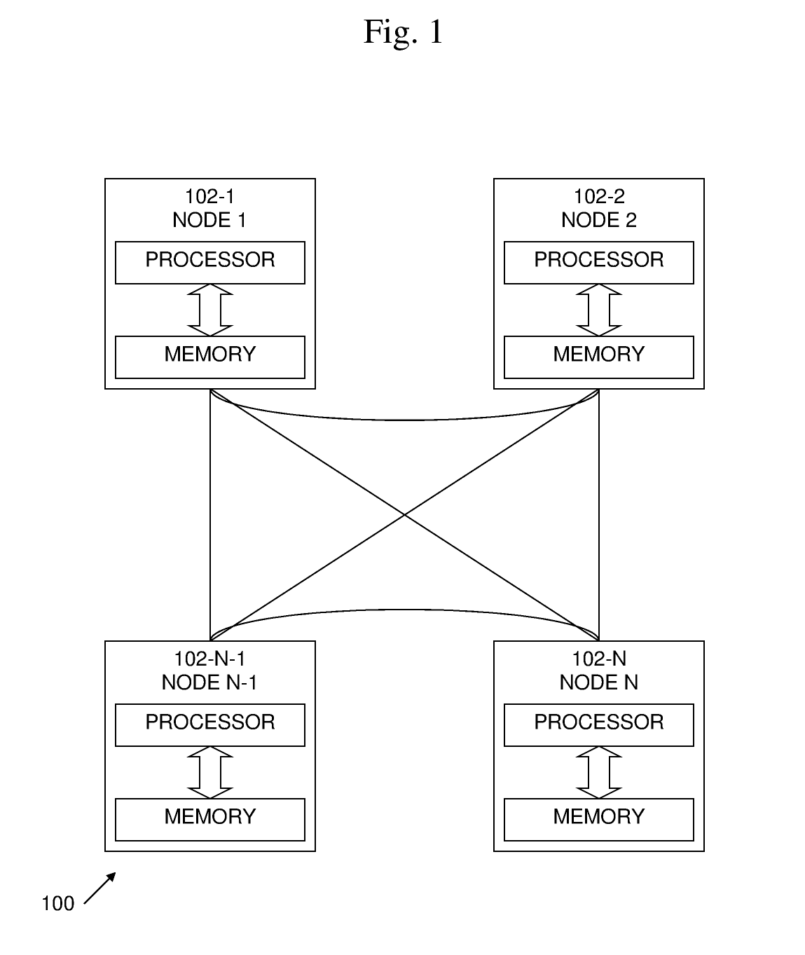

An exemplary distributed computing system is shown in FIG. 1. Distributed computing systems are typically groups of networked computers, which have the same goal for their work, such as each processing a portion of the same computing task. In this example, there are a plurality of computing nodes, such as node 1 102-1, node 2 102-2, through node N−1 102N−1 and node N 102N. Each node 102-1-102-N may be a complete computer system including one or more processors, memory, and communication circuitry. Information may be exchanged among nodes by passing messages between the processors using the communication circuitry. Typically, each node is communicatively connected to one or more other nodes. However, in larger distributed systems, each node is typically not directly communicatively connected to every other node. The arrangement shown in FIG. 1 is merely an example. The present invention contemplates any number, arrangement, or communicative connection of nodes in the distributed system.

A typical data analytics problem may involve a dataset of, for example, m data points, and a data analytics model that is to be fitted to the dataset. Typically, the model itself is more concise, in terms of the amount of information needed to specify it, than the dataset itself. For very large datasets, which are typically much larger than the available memory in each node, the fitting process involves processing only a portion, known as a batch, of the dataset at a time, updating the model, then moving on to the next batch.

Hypothetically, if the entire dataset would fit on a single node, and the time necessary to perform the fitting on that single node was not an issue, the globally optimal model, M_{ideal}, could be generated on that single node, as all the information (data) is available on that node. With a batched or online fitting, this could be achieved by integrating data points into the model successively, in some order.

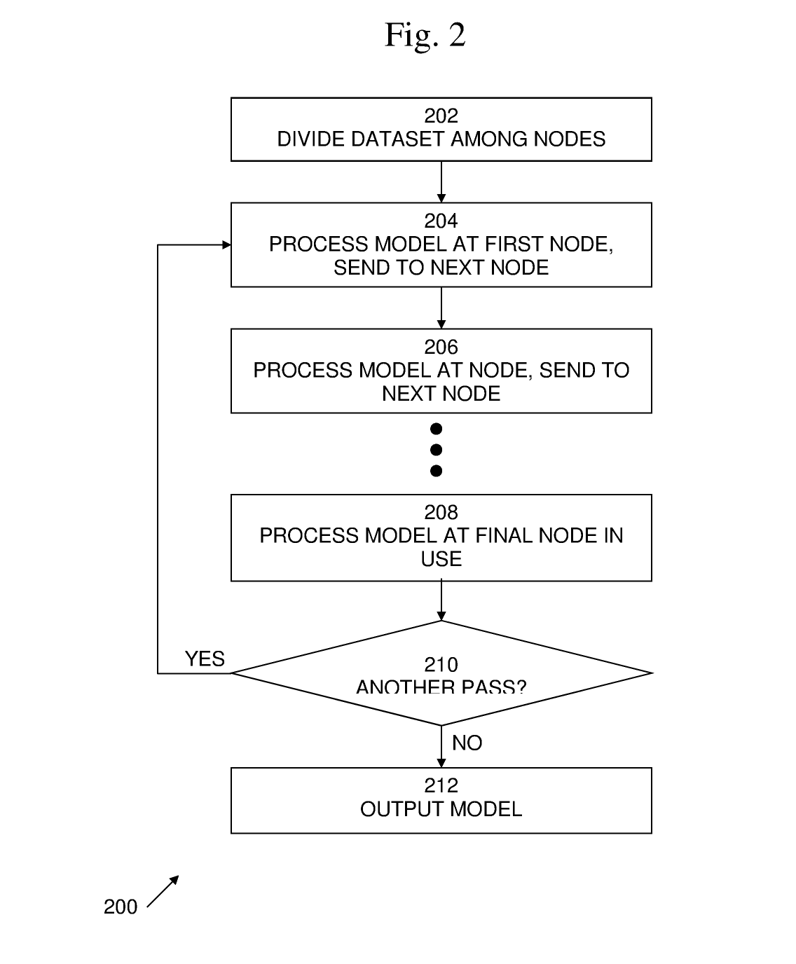

An exemplary flow diagram of a process 200 for distributed data analytics model fitting is shown in FIG. 2. It is best viewed in conjunction with FIG. 1. With this approach, a model equivalent to M_{ideal} may be generated, despite the data being distributed, while using only a relatively small amount of inter-node communication, and with no movement of the original dataset from node to node. Process 200 begins with 202, in which the dataset may be divided among nodes. For example, if there are N nodes and the dataset includes m datapoints, then each node 102-1 to 102-N would receive m/N datapoints.

At 204, an initial or “empty” model may be sent to a first node, such as node 102-1. Node 102-1 may then integrate the data points in its portion of the dataset into the model in a batched fashion, then send the processed model to the next (second) node, such as node 2 102-2. At 206, the next node, such as node 2 102-2, may then integrate the data points in its portion of the dataset into the model, then send the processed model to the next node. The processing at 206 may be repeated for each successive node until, at 208, the processed model is sent to the final node in use. For example, the final node in use may be the final available node, such as node N 102-N, in which case all available nodes have been used. Alternatively, the final node in use may not be the final available node. For example, node N−1 102-N−1 may be the last node to be used to perform processing. In this case, fewer than all available nodes have been used. The last node used may then integrate the data points in its portion of the dataset into the model. At this point, one pass of the model through the dataset has been completed. At 210, it may be determined whether another pass is necessary. If another pass is necessary, then the model may be sent back to node 1 at 204, and the processing may be repeated as many times as necessary. If another pass is not necessary, then at 212, the processed model may be output. The model ultimately generated by process 200, M_{distributed}, may be considered to be equivalent to M_{ideal}. Thus, M_{distributed} may have similar accuracy to a data analytics model trained by training the data analytics model with the dataset sequentially.

It is to be noted that the distribution of portions of the dataset across the nodes, and the order in which the model is then processed by the nodes, has an effect on the processed model, M_{distributed}, that is generated. Given this, an M_{distributed}, that is equivalent to M_{ideal} may or may not be generated efficiently. However, more processed models may be communicated among nodes, so that many orders in which the model is processed by the nodes may be replicated. Furthermore, to achieve an M_{ideal} equivalent model, using the exact same order is not apriori necessary as the order that lead to M_{ideal} is not apriori better than any other order of processing.

The method presented so far enables data parallelism, in that it produces an equally accurate model as in the sequential case while not requiring all the data to be present on the same node. However, it does not improve the speed of the model fitting (no computational parallelism). However, in the context we have described, which is typical of exploratory machine learning, where multiple model and data configurations need to be evaluated, we can achieve computational parallelism from evaluating these different models in parallel. For example, there may be a plurality of models to be fitted on the dataset. This plurality of models may be independent or may result from varying and choosing different combinations of model structure, model meta-parameters that are not learned through training, and training algorithm parameters. Embodiments may provide the capability for training multiple models of said plurality of models simultaneously by performing the previously described single-model fitting process (see para. 0020 above) on different successions of nodes. For example, assume that there are Nodes 1, 2, and 3 and three models X, Y, and Z. In the first training step the untrained model X may be sent to node 1, the untrained model Y may be sent to node 2 and the untrained model Z may be sent to node 3. Once the first training step of integrating the dataset is done, the (partially) trained model X may be sent to node 2, the (partially) trained model Y may be sent to node 3 and the (partially) trained model Z may be sent to node 1 and so on.

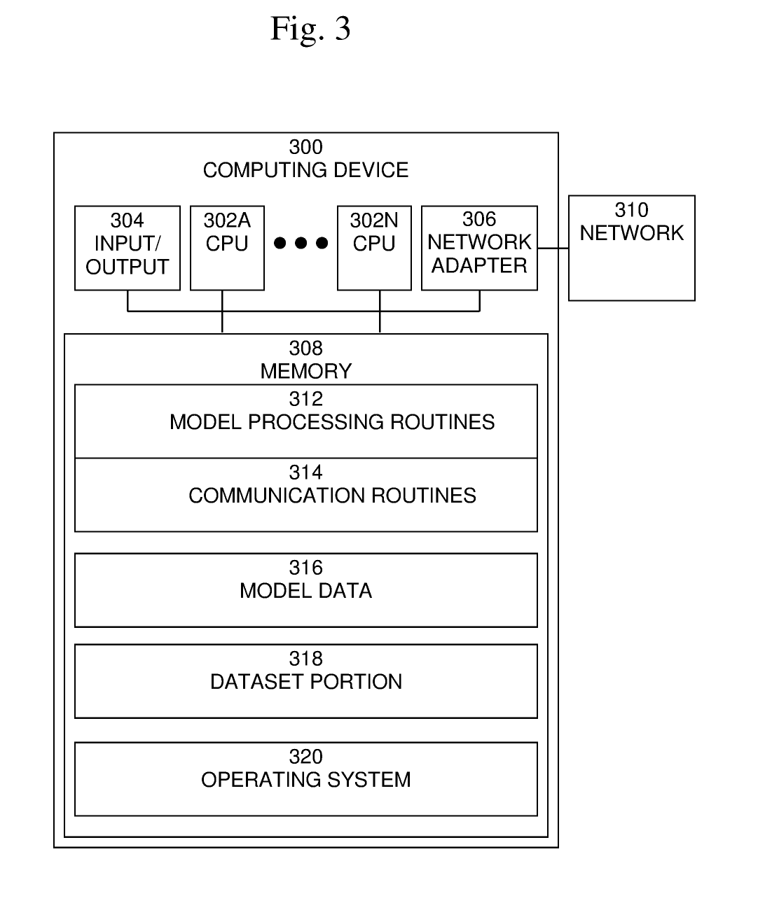

An exemplary block diagram of a computing device 300, in which processes involved in the embodiments described herein may be implemented, such as those processes performed by nodes 1-N 102-1-102-N of FIG. 1, is shown in FIG. 3. Computing device 300 is typically a programmed general-purpose computer system, such as an embedded processor, system on a chip, personal computer, workstation, server system, and minicomputer or mainframe computer. Likewise, computing device 300 may be implemented in a wrist-worn, or other personal or mobile device, and may include sensor circuitry as well as display circuitry to display object identification information. Computing device 300 may include one or more processors (CPUs) 302A-302N, input/output circuitry 304, network adapter 306, and memory 308. CPUs 302A-302N execute program instructions in order to carry out the functions of the present invention. Typically, CPUs 302A-302N are one or more microprocessors, such as an INTEL PENTIUM® processor. FIG. 3 illustrates an embodiment in which computing device 300 is implemented as a single multi-processor computer system, in which multiple processors 302A-302N share system resources, such as memory 308, input/output circuitry 304, and network adapter 306. However, the present invention also contemplates embodiments in which computing device 300 is implemented as a plurality of networked computer systems, which may be single-processor computer systems, multi-processor computer systems, or a mix thereof.

Input/output circuitry 304 provides the capability to input data to, or output data from, computing device 300. For example, input/output circuitry may include input devices, such as keyboards, mice, touchpads, trackballs, scanners, analog to digital converters, etc., output devices, such as video adapters, monitors, printers, etc., and input/output devices, such as, modems, etc. Network adapter 306 interfaces device 300 with a network 310. Network 310 may be any public or proprietary LAN or WAN, including, but not limited to the Internet.

Memory 308 stores program instructions that are executed by, and data that are used and processed by, CPU 302 to perform the functions of computing device 300. Memory 308 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface.

The contents of memory 308 may vary depending upon the function that computing device 300 is programmed to perform. In the example shown in FIG. 3, exemplary memory contents are shown representing routines and data for embodiments of the processes described above, such as those processes performed by nodes 1-N 102-1-102-N of FIG. 1. However, one of skill in the art would recognize that these routines, along with the memory contents related to those routines, may not be included on one system or device, but rather may be distributed among a plurality of systems or devices, based on well-known engineering considerations. The present invention contemplates any and all such arrangements.

In the example shown in FIG. 3, memory 308 may include model processing routines 312, communication routines 314, model data 316, dataset portion 318, and operating system 320. For example, model processing routines 312 may include routines that integrate the data points in a node's portion of the dataset 318 into the model data 316. Communication routines 314 may include routines to receive dataset data and processed model data and to send processed model data. Model data 316 may include data representing the model being processed, and into which a node's portion of the dataset 318 may be integrated. Dataset portion 318 may include a node's portion of the dataset being used to generate the current model. Operating system 320 provides overall system functionality.

As shown in FIG. 3, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including Linux, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A computer-implemented method for training of data analytics models comprising:
dividing a dataset among a plurality of processing nodes, each processing node comprising at least one processor, memory, and communications circuitry, the memory of each processing node storing a different portion of the dataset;
performing a first training pass on an untrained data analytics model by:
receiving at a first node the untrained data analytics model;
training the untrained data analytics model by integrating the portion of the dataset stored on the first node into the data analytics model;
repeating transmitting the data analytics model to a next node and training the data analytics model at the next node by integrating the portion of the dataset stored on the next node into the data analytics model until the data analytics model has been trained by at least a portion of the plurality of processing nodes; and
outputting the trained data analytics model.

2. The method of claim 1, wherein the method further comprises:
performing at least one additional training pass on the data analytics model.

3. The method of claim 1, wherein the output trained data analytics model has similar accuracy to a data analytics model trained by training the data analytics model with the dataset sequentially.

4. The method of claim 1, further comprising:
training a plurality of data analytics models, the plurality of data analytics models resulting from varying and choosing different combinations of model structure, model meta-parameters that are not learned through training, and training algorithm parameters.

5. The method of claim 4, further comprising:
training the plurality of data analytics models simultaneously using the plurality of processing nodes, each data analytics model trained on the plurality of processing nodes using a different succession of processing nodes than the successions of processing nodes with which other data analytics models are trained.

6. The method of claim 1, further comprising:
training a plurality of data analytics models, wherein at least some of the plurality of data analytics models are independent of each other; and
training the plurality of data analytics models simultaneously using the plurality of processing nodes, each data analytics model trained on the plurality of processing nodes using a different succession of processing nodes than the successions of processing nodes with which other data analytics models are trained.

7. A computer program product for training of data analytics models, the computer program product comprising a non-transitory computer readable storage having program instructions embodied therewith, the program instructions executable by a computer, to cause the computer to perform a method comprising:
dividing a dataset among a plurality of processing nodes, each processing node comprising at least one processor, memory, and communications circuitry, the memory of each processing node storing a different portion of the dataset;
performing a first training pass on an untrained data analytics model by:
receiving at a first node the untrained data analytics model;
training the untrained data analytics model by integrating the portion of the dataset stored on the first node into the data analytics model;
repeating transmitting the data analytics model to a next node and training the data analytics model at the next node by integrating the portion of the dataset stored on the next node into the data analytics model until the data analytics model has been trained by at least a portion of the plurality of processing nodes; and outputting the trained data analytics model.

8. The computer program product of claim 7, further comprising program instructions for:
performing at least one additional training pass on the data analytics model.

9. The computer program product of claim 7, wherein the output trained data analytics model has similar accuracy to a data analytics model trained by training the data analytics model with the dataset sequentially.

10. The computer program product of claim 7, further comprising program instructions for:
training a plurality of data analytics model, the plurality of data analytics models resulting from varying and choosing different combinations of model structure, model meta-parameters that are not learned through training, and training algorithm parameters.

11. The computer program product of claim 10, further comprising program instructions for:
training the plurality of data analytics models simultaneously using the plurality of processing nodes, each data analytics model trained on the plurality of processing nodes using a different succession of processing nodes than the successions of processing nodes with which other data analytics models are trained.

12. The computer program product of claim 7, further comprising:
training a plurality of data analytics models, wherein at least some of the plurality of data analytics models are independent of each other; and
training the plurality of data analytics models simultaneously using the plurality of processing nodes, each data analytics model trained on the plurality of processing nodes using a different succession of processing nodes than the successions of processing nodes with which other data analytics models are trained.

13. A system for training of data analytics models, the system comprising a processor, memory accessible by the processor, and computer program instructions stored in the memory and executable by the processor to perform:
dividing a dataset among a plurality of processing nodes, each processing node comprising at least one processor, memory, and communications circuitry, the memory of each processing node storing a different portion of the dataset;
performing a first training pass on an untrained data analytics model by:
receiving at a first node the untrained data analytics model;
training the untrained data analytics model by integrating the portion of the dataset stored on the first node into the data analytics model;
repeating transmitting the data analytics model to a next node and training the data analytics model at the next node by integrating the portion of the dataset stored on the next node into the data analytics model until the data analytics model has been trained by at least a portion of the plurality of processing nodes; and outputting the trained data analytics model.

14. The system of claim 13, further comprising computer program instructions for:
performing at least one additional training pass on the data analytics model.

15. The system of claim 13, wherein the output trained data analytics model has similar accuracy to a data analytics model trained by training the data analytics model with the dataset sequentially.

16. The system of claim 13, further comprising computer program instructions for:
training a plurality of data analytics models, the plurality of data analytics models resulting from varying and choosing different combinations of model structure, model meta-parameters that are not learned through training, and training algorithm parameters.

17. The system of claim 16, further comprising computer program instructions for:
training the plurality of data analytics models simultaneously using the plurality of processing nodes, each data analytics model trained on the plurality of processing nodes using a different succession of processing nodes than the successions of processing nodes with which other data analytics models are trained.

18. The system of claim 13, further comprising:
training a plurality of data analytics models, wherein at least some of the plurality of data analytics models are independent of each other; and
training the plurality of data analytics models simultaneously using the plurality of processing nodes, each data analytics model trained on the plurality of processing nodes using a different succession of processing nodes than the successions of processing nodes with which other data analytics models are trained.
